(19) United States
(12) Patent Application Publication
(10) Pub. No.: US 2014/0029614 A1
(43) Pub. Date: Jan. 30, 2014

(54) FORWARDING A MULTICAST MESSAGE

(71) Applicant: Ruitao Xie, Beijing (CN)

(72) Inventor: Ruitao Xie, Beijing (CN)

(73) Assignee: Hangzhou H3C Technologies C0.,ltd, Hangzhou (CN)

(21) Appl. No.: 13/985,829

(22) PCT Filed: Apr. 19, 2012
(86) PCT No.: PCT/CN2012/074340

§ 371 Date: Aug. 15, 2013

(30) Foreign Application Priority Data
Apr. 21, 2011 (CN) 201110100674.5

(51) Int. Cl. H04L 12/18

(52) U.S. Cl. CPC H04L 12/185
USPC 370/390

(57) ABSTRACT

According to an example, when configuring a multicast entry on an interface board, if the multicast entry is in hash conflict with multicast entries already configured on the interface board, configuring the multicast entry onto the master control board; when an interface board at the inlet receives a multicast message, searching in the multicast entries configured on the interface board for a multicast entry that matches said multicast message; and if a matching multicast entry is found, forwarding said multicast message according to the matching multicast entry; otherwise, sending the multicast message to the master control board; and searching in the multicast entries configured on the master control board for a multicast entry that matches the multicast message; and if a matching multicast entry is found, forwarding said multicast message according to the matching multicast entry.

### BACKGROUND

Some switches forward multicast messages by using multicast forwarding hardware, wherein multicast (S, G, V) information can be realized by using a hash table. A hash table comprises a plurality of hash buckets, wherein each hash bucket corresponds to a certain storage space and has a certain amount of multicast (S, G, V) information stored therein. The hash key of the multicast (S, G, V) information in a particular hash bucket is the same, herein S represents a specific multicast source, G represents a specific multicast group and V represents an inlet virtual local area network VLAN.

When forwarding a multicast message, a switch searches for a corresponding L3_entry entry according to the multicast (S, G, V) information of the multicast message. Having found a corresponding L3_entry, the switch searches for an IP Multimedia Communication IPMC entry according to the L3_entry entry and forwards the multicast message in accordance with the outlet in the IPMC entry.

### BRIEF DESCRIPTION OF THE FIGURES

FIG. 1 is a schematic diagram of the flow of forwarding a multicast message by a network device according to an example.

FIG. 2 is a second schematic diagram of the flow of forwarding a multicast message by a network device according to an example.

FIG. 3 is a schematic diagram of the flow of configuring a multicast entry according to an example.

FIG. 4 is a schematic diagram of the flow of forwarding a multicast message according to an example.

FIG. 5 is a schematic diagram of the overall architecture when a network device according to an example forwards a multicast message.

FIG. 6 is a schematic diagram of the structure of the master control board in the network device according to an example.

FIG. 7 is a schematic diagram of structure of the network device according to an example.

### DETAILED DESCRIPTION

An example hash table is shown in Table 1.

TABLE 1

| | | | | | | |
|---|---|---|---|---|---|---|
| Hash bucket 1 | S1, G1, V1 | S2, G2, V2 | S3, G3, V3 | S4, G4, V4 | S5, G5, V5 | S6, G6, V6 |
| Key = key1 | | | | | | |
| Hash bucket 2 | S1′, G1′, V1′ | S2′, G2′, V2′ | S3′, G3′, V3′ | | | |
| Key = key2 | | | | | | |
| Hash bucket 3 | S1″, G1″, V1″ | S2″, G2″, V2″ | S3″, G3″, V3″ | S4″, G4″, V4″ | | |
| Key = key3 | | | | | | |
| Hash bucket 4 | | | | | | |
| Key = key4 | | | | | | |

When configuring multicast (S, G, V) information into a hash bucket, if the hash bucket has been filled, the configuration of the multicast (S, G, V) information fails since the hash bucket has reached the maximum capacity, thus the corresponding multicast message with the multicast (S, G, V) information cannot be forwarded.

As shown in Table 1, multicast (S1, G1, V1) to (S6, G6, V6) information having the same hash key, namely, key 1, will be configured into a hash bucket whose hash key is key 1. When this bucket has reached the maximum capacity and new multicast (S7, G7, V7) information with key 1 needs to be configured therein, the configuration of the multicast (S7, G7, V7) information will fail since hash bucket 1 has no storage space, and this situation is called a hash conflict.

Multicast entries related to layer-2 or layer-3 forwarding on a network device generally comprise a L3_entry entry and an IPMC entry, etc. The L3-entry entry is solidified in the hardware of the network device and stored with (S, G, V) information, wherein each (S, G, V) corresponds to a L3-entry entry, and each. L3-entry entry corresponds to an IPMC index for indexing the corresponding IPMC entry. Information related to all outlets on the current board is usually recorded in the IPMC entry. The (S, G, V) information in a L3_entry entry is stored in the form of a hash table (as shown in Table 1), wherein each hash bucket can accommodate a certain amount of entries, which is usually 8 entries.

As shown in FIG. 1, on the interface board at the inlet of the message on a network device, multicast forwarding is implemented by searching for the L3_entry entry through the (S, G, V) information of the message to obtain the IPMC index, finding the IPMC entry through the IPMC index and finding all the outlets of the current board through the IPMC entry, and then copying and forwarding the message from these outlets.

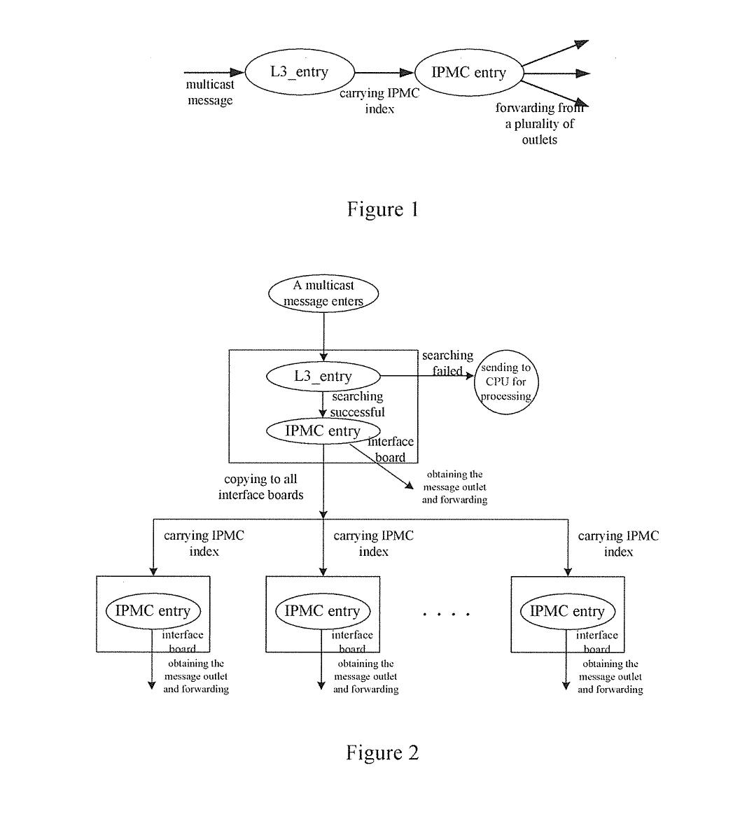

For a distributed network device, as shown in FIG. 2, multicast forwarding flow is implemented by, on the interface board at the inlet of a message, searching for the L3_entry entry through the (S, G, V) information of the message to obtain the IPMC index, finding the IPMC entry through the IPMC index and finding all the outlets of the current board through the IPMC entry, copying and forwarding the message through the outlets of the current board, besides, sending the multicast message and the IPMC index to other interface boards together; on the target interface board, finding the IMPC entry again through the IPMC index, finding all the outlets on the respective interface boards through the IPMC entry, and then forwarding the message from these outlets.

The forwarding of a multicast message is realized through determining whether the (S, G, V) information of the multicast message matches the (S, G, V) information of a L3_entry entry. However, when adding (S, G, V) information into a L3_entry entry, if a hash conflict occurs due to the inherent characteristics of a hash table (the capacity of a hash bucket is limited), the configuration of the (S, G, V) information fails, thus the corresponding multicast message with the (S, G, V) information cannot be forwarded.

From the abovementioned flow of forwarding a multicast message by a network device according an example, it can be seen that the master to control board on the network device does not have a traffic forwarding interface, thus, the switching chip of the master control board does not participate in the multicast forwarding practically. Therefore, the master control board does not need to distribute multicast entries.

According to another example of the present disclosure, in addition to interface boards of a network device, the master control board of the network device also has multicast entries (such as L3_entry entries) configured thereon. The structure of the multicast entries stored in the master control board can be the same as that of the multicast entries in the interface boards, wherein the multicast entries stored in the master control board are multicast entries that are in hash conflict with the multicast entries in the interface boards. When an interface board at the inlet receives a multicast message, if a multicast entry that matches the multicast message has not been found, the master control board is used as a proxy to search for a matching multicast entry in its own multicast entries and perform forward processing in accordance with the found multicast entry, whereby the problem of a hash conflict is solved.

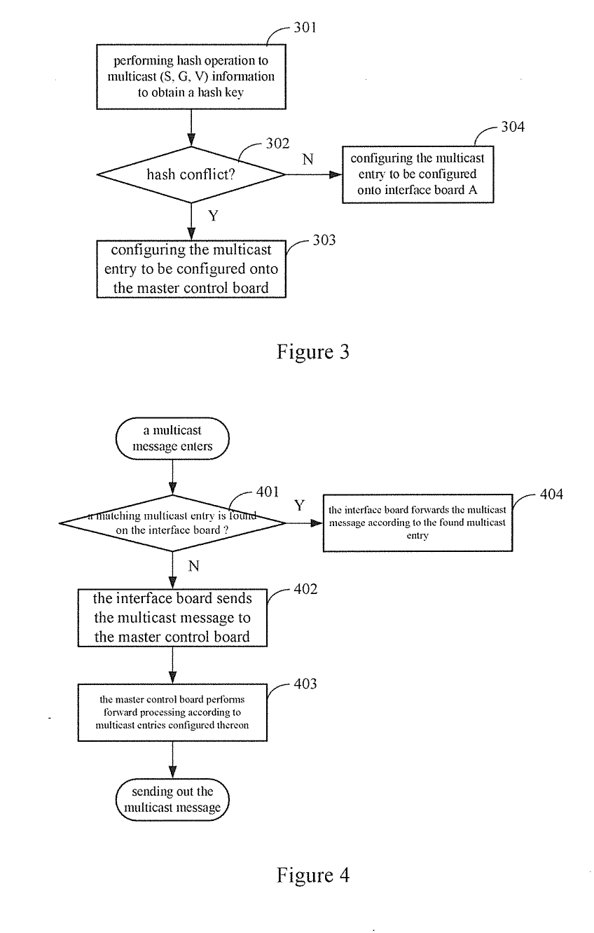

The flow of configuring a multicast entry and the flow of forwarding a multicast message based on the multicast entry according to an example are described in detail in combination with FIG. 3 and FIG. 4.

FIG. 3 is the flow of configuring a multicast entry according to an example. Taking an interface board (indicated by interface board A) in a network device as an example, when there is a new multicast entry with multicast (S, G, V) information that needs to be configured, the flow may comprise:

Block 301, performing hash operation to the multicast (S, G, V) information to obtain the hash key.

Block 302, determining whether the multicast entry to be configured is in conflict with multicast entries that are already stored in the interface board A, in accordance with the obtained hash key, if so, going to block 303, otherwise, going to block 304.

Specifically, the obtained hash key of the multicast entry is compared to the hash key corresponding to each hash bucket in a L3_entry table of the interface board A. If the obtained hash key of the multicast entry to be configured is the same as the hash key corresponding to a specific hash bucket in the L3_entry table, and the hash bucket has currently reached its maximum capacity, that is, a hash conflict occurs, then go to block 303; otherwise, go to block 304.

Block 303, configuring said multicast entry to be configured onto the master control board.

Specifically, the multicast (S, G, V) information is added into a hash bucket that has the same hash key as the multicast (S, G, V) information in a L3_entry table of the master control board. A corresponding IPMC entry also needs to be configured on the interface boards. When the hash bucket corresponding to the hash key of the multicast (S, 0, V) information has currently reached its maximum capacity, configuration of the multicast entry will be abandoned.

Block 304, configuring the multicast entry to be configured onto the interface board A.

Specifically, the multicast (S, G, V) information can be added into a L3_entry table of the current board in the existing manner. Wherein, if the hash key of the entry to be configured is the same as that of a specific hash bucket in the L3_entry table on the interface A, and the hash bucket has not currently reached its maximum capacity, then adding the multicast (S, G, V) information into said hash bucket.

The aforesaid flow describes the process of configuring a multicast entry only taking one interface board in a network device as an example.

The aforesaid processing can be performed to each of interface boards that can serve as a multicast inlet in a network device. In normal cases, each of the interface boards in a network device can serve as a multicast inlet.

From the foregoing flow it can be seen that a multicast entry is configured into a L3_entry table of each interface board in the existing manner, when there is no hash conflict and the multicast entry can be configured normally. As shown in Table 1, multicast entries (S1, G1, V1), (S2, G2, V2) and (S3, G3, V3), etc., are configured onto all interface boards but not configured onto the master control board; while a multicast entry that is configured unsuccessfully on an interface board due to a hash conflict is configured onto the master control board, for example, the entry (S7, G7, V7) that is in hash conflict with the L3_entry entries of the interface boards will be configured onto the master control board, but not configured onto the interface boards, and only a corresponding IPMC entry is configured onto the interface boards, whereby occurrence of a hash conflict can be avoided during configuration of a multicast entry.

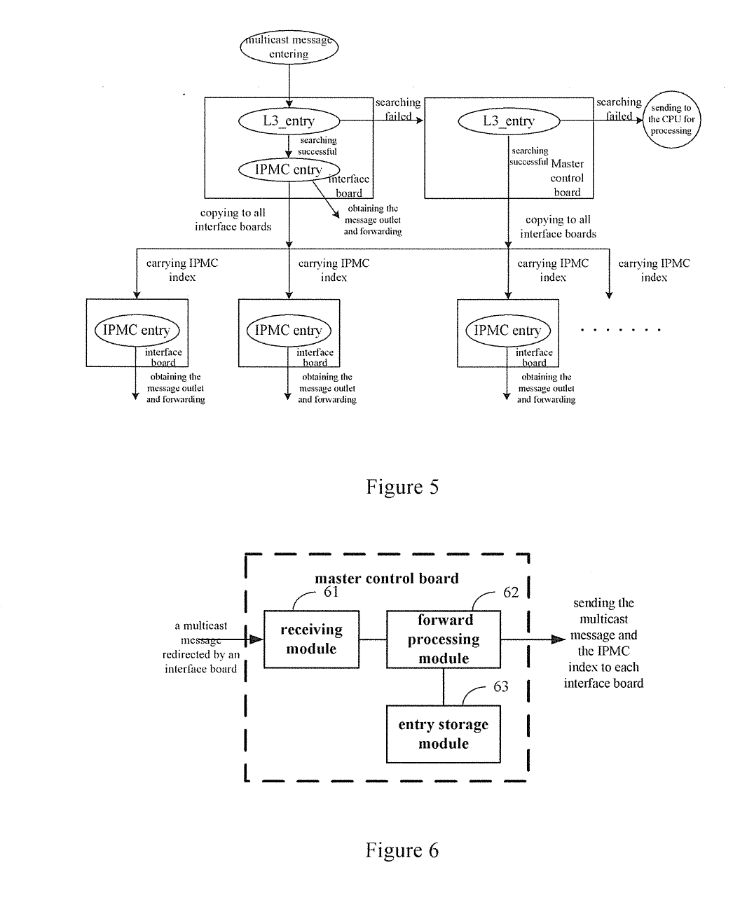

For a multicast entry configured in the aforesaid manner, the flow of forwarding its multicast message can be as shown in FIG. 4 or FIG. 5, wherein FIG. 4 is a flow diagram and FIG. 5 is a schematic diagram of the overall architecture of the multicast message forwarding flow. When there is a multicast message flowing into the network device, taking the interface board A in the network device acting as the interface board at the inlet of a multicast message as an example, the flow of forwarding a multicast message may comprise:

Block 401, after receiving a multicast message, the interface board A searches for the multicast entries configured locally in accordance with the (S, G, V) information of the multicast message, if a multicast entry that matches the (S, G, V) information of the multicast message is found, then go to block 405; otherwise, go to block 402.

Specifically, after receiving a multicast message, the interface board A finds out whether (S, G, V) information of the multicast message matches the (S, G, V) information stored in a L3_entry entry. If so, then go to block 405; otherwise, go to block 402.

Block 402, the interface board A sends the multicast message to the master control board.

Specifically, an Access Control List ACL can be preset on the interface board A, wherein the ACL is used for re-directing the multicast message to the master control board when matching of the multicast entry on the current board fails.

Block 403, the master control board searches for a multicast entry configured locally in accordance with the (S, G, V) information of the multicast message and, if a multicast entry that matches the (S, G, V) information of the multicast message is found, it forwards said multicast message according to the matching multicast entry.

Specifically, the master control board finds out whether the (S, G, V) information of the multicast message matches the (S, G, V) information stored in a L3_entry entry. If so, then a corresponding IPMC index is obtained in accordance with the L3_entry entry and the multicast message and the IPMC index are copied to each interface board. Each target interface board searches for a corresponding IPMC entry in accordance with the IPMC index, and copies the multicast message to the corresponding outlet on the current board in accordance with the IPMC entry to send out.

Block 404, the interface board A forwards the multicast message in accordance with the found multicast entry.

Specifically, after finding the matching (S, G, V) information in a L3_entry entry in accordance with the multicast message, the interface board A obtains an IPMC index through the (S, G, V) information, finds a corresponding IPMC entry in accordance with the IPMC index and copies the multicast message to a corresponding outlet on the current board in accordance with the IPMC entry. Furthermore, it also copies the multicast message and the IPMC index to other interface boards of the network device, each of the target interface boards finds a corresponding IPMC entry in accordance with the IPMC index, and copies the multicast message to the corresponding outlet on the current board in accordance with the IPMC entry.

In the foregoing flow, if the master control board fails to find a matching multicast entry, it will treat the multicast message as an unknown multicast message, e.g. send to the CPU for processing.

From the above flow it can be seen that: when forwarding a multicast message, if a matching multicast entry is found on the interface board in accordance with the (S, G, V) information of the multicast message, then performing forward processing in the existing manner; otherwise, redirecting the multicast message to the master control board; then re-searching a matching multicast entry in a proxy manner on the master control board, if found, obtaining a corresponding IPMC index and perform the forward processing based on the corresponding IPMC entry. From this it can be seen that such processing is equivalent to doubling the depth of the hash bucket of the L3_entry entries in the network device, whereby probability of occurrence of a hash conflict is reduced and the usability of the network device is enhanced. The examples of the present disclosure solve the problem of multicast hash conflict to some extent by means of the master control board acting as a proxy, which increases the practicability of multicast function significantly.

Based on the same technical concept, the present disclosure further provides a master control board for use in a network device and a network device comprising said master control board.

FIG. 6 is a schematic diagram of the structure of the master control board in the network device comprising a master control board and at least one interface board according to an example. As shown in FIG. 6, the master control board may comprise:

an entry storage module 61, which is a hardware module (e.g. a memory or non-transitory storage medium), to store in a L3_entry table multicast entries that are in hash conflict with multicast entries already configured on an interface board;

a receiving module 62, to receive a multicast message redirected to the master control board by an interface board;

a forward processing module 63 to, when a multicast entry that matches said multicast message is found in the multicast entries stored in said entry storage module 61, forward said multicast message according to the matching multicast entry.

In the aforesaid master control board, said forward processing module 63 is to find out whether there is a multicast entry that matches the address and VLAN information of said multicast message in a L3_entry table stored in said entry storage module 61, if so, then copy said multicast message and an IPMC index corresponding to the matching multicast entry to each interface board, so that each interface board finds a corresponding IPMC entry according to said IPMC index and forwards said multicast message to a downstream device according to the outlet in said IPMC entry.

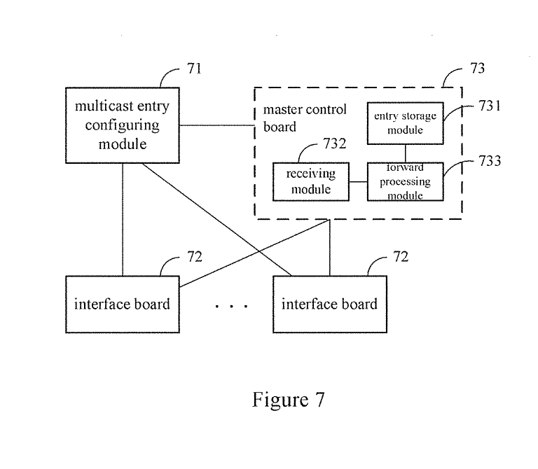

FIG. 7 is a schematic diagram of the structure of the network device according to an example. As shown in FIG. 7, the network device may comprise: a multicast entry configuring module 71, at least one interface board 72 and a master control board 73; wherein:

the multicast entry configuring module 71 to, when a multicast entry to be configured on an interface board 72 is in hash conflict with multicast entries already configured on the interface board 72, configure it onto the master control board 73;

each interface board 72 to, when receiving a multicast message as a multicast inlet, search in the multicast entries configured on the interface board 72 for a multicast entry that matches the multicast message; if a matching multicast entry is found, forward said multicast message according to the matching multicast entry; otherwise, send said multicast message to the master control board 73; and

said master control board 73 to, when a multicast entry that matches said multicast message is found in the multicast entries configured thereon, forward said multicast message according to the matching multicast entry.

In the aforesaid network device, said multicast entry configuring module 71 is to, determine a hash keyword corresponding to a multicast entry to be configured based on the (S, G, V) information of the multicast entry; and configure the multicast entry according to the determined hash keyword.

In the aforesaid network device, said multicast entry configuring module 71 is further to compare the hash keyword of the multicast entry with the hash keyword of each hash bucket for storing multicast entries in a L3_entry table on the interface board, if the hash keyword of the multicast entry is identical with the hash keyword of a hash bucket in the L3_entry table, and the hash bucket has currently reached the maximum capacity, then configure the (S, G, V) information of the multicast entry into a hash bucket having the same hash keyword in a L3_entry table of the master control board 73 in case that this hash bucket has not reached the maximum capacity.

In the aforesaid network device, said multicast entry configuring module 71 is further to configure an IPMC index corresponding to each of the hash buckets on the master control board 73, and configure an IPMC entry corresponding to the IPMC index on each interface board 72.

In the aforesaid network device, said master control board 73 may comprise:

an entry storage module 731, which is a hardware module, to store in a L3_entry table multicast entries that are in hash conflict with multicast entries already configured on an interface board;

a receiving module 732 to receive a multicast message redirected to the master control board by an interface board;

a forward processing module 733 to, when a multicast entry that matches said multicast message is found in the multicast entries stored in said entry storage module 731, forward said multicast message according to the matching multicast entry.

Wherein the forward processing module 733 is specifically to find out whether there is a multicast entry that matches the address and VLAN information of said multicast message in a L3_entry table stored in said entry storage module, if so, then copy said multicast message and an IPMC index corresponding to the matching multicast entry to each interface board, so that each interface board finds a corresponding IPMC entry according to said IPMC index and forwards said multicast message to a downstream device according to the outlet in said IPMC entry.

In the present disclosure, when configuring a multicast entry on an interface board, a multicast entry that is in hash conflict with multicast entries already configured on the interface board is configured onto the master control board, such that when an interface board at the inlet receives a multicast message, a multicast entry that matches said multicast message is searched for in the multicast entries configured on the interface board; and if no matching multicast entry is found, the multicast message is sent to the master control board; the master control hoard searches for a multicast entry that matches the multicast message in the multicast entries configured thereon, and if a matching multicast entry is found, the master control board forwards said multicast message according to the matching multicast entry. In this way, the probability of occurrence of a hash conflict is reduced and the usability of a network device is enhanced, thus the problem of multicast hash conflict is solved to some extent and the practicability of multicast function is thereby enhanced.

From the above depiction of the implementation mode, the above examples can be implemented by hardware, software or firmware or a combination thereof. For example the various methods, processes and functional units such as receiving module, forward processing module, multicast entry configuring module etc. described herein may be implemented by a processor (the term processor is to be interpreted broadly to include a CPU, processing unit, ASIC, logic unit, or programmable gate array etc.) The processes, methods and functional units may all be performed by a single processor or split between several processers. They may be implemented as machine readable instructions executable by one or more processors. Further the teachings herein may be implemented in the form of a software product. The computer software product is stored in a storage medium and comprises a plurality of instructions for making a computer device (which can be a personal computer, a server or a network device, etc.) implement the method recited in the examples of the present disclosure.

The figures are only illustrations of an example, wherein the modules or procedure shown in the figures are not necessarily essential for implementing the present disclosure. Moreover, the sequence numbers of the above examples are only for description, and do not indicate an example is more superior to another.

Those skilled in the art can understand that the modules in the device in the example can be arranged in the device in the example as described in the example, or can be alternatively located in one or more devices different from that in the example. The modules in the aforesaid example can be combined into one module or further divided into a plurality of sub-modules.

Although the flow diagrams described above show a specific order of execution, the order of execution may differ from that which is depicted. For example, the order of execution of two or more blocks may be scrambled relative to the order shown. Also, two or more blocks shown in succession may be executed concurrently or with partial concurrence. All such variations are within the scope of the present disclosure.

1. A method for forwarding a multicast message in a network device comprising a master control board and at least one interface board, wherein the master control board and the at least one interface board are both configured with multicast entries in the form of a hash table, the method comprises:
when configuring a multicast entry on an interface board, if the multicast entry is in hash conflict with multicast entries already configured on the interface board, configuring the multicast entry onto the master control board;
when an interface board at the inlet receives a multicast message, searching in the multicast entries configured on the interface board for a multicast entry that matches said multicast message; if a matching multicast entry is found, forwarding said multicast message according to the matching multicast entry; otherwise, sending the multicast message to the master control board; and
searching in the multicast entries configured on the master control board for a multicast entry that matches the multicast message; and if a matching multicast entry is found, forwarding said multicast message according to the matching multicast entry.

2. The method according to claim 1, wherein when configuring a multicast entry on an interface board, if the multicast entry is in hash conflict with multicast entries already configured on the interface board, configuring it onto the master control board, comprises:
determining a hash keyword corresponding to a multicast entry based on the (S, G, V) information of the multicast entry; and
configuring the multicast entry according to the determined hash keyword.

3. The method according to claim 2, wherein said configuring the multicast entry according to the determined hash keyword comprises:
comparing the hash keyword of the multicast entry with the hash keywords of the hash buckets for storing multicast entries in a L3_entry table of said interface board,
if the hash keyword of the multicast entry is identical with the hash keyword of a hash bucket in the L3_entry table, and said hash bucket has currently reached the maximum capacity, then
configuring the (S, G, V) information of the multicast entry into a hash bucket having the same hash keyword in a L3_entry table of the master control board, in case that this hash bucket has not reached the maximum capacity.

4. The method according to claim 3, further comprising: configuring an IPMC entry corresponding to the (S, G, V) information of said multicast entry on each interface board, and configuring an index of the IPMC entry corresponding to the L3_entry entry on the master control board.

5. The method according to claim 1, wherein:
said master control board finds out whether there is a multicast entry that matches the (S, G, V) information of the multicast message in the L3_entry entries configured on the master control board; if so, then the master control board copies said multicast message and an IPMC index corresponding to the matching multicast entry to other interface boards;
said other interface boards find a corresponding IPMC entry according to said IPMC index and forward said multicast message to a downstream device according to the outlet in said IPMC entry.

6. The method according to claim 5, further comprising: when failing to find a multicast entry that matches said multicast message, said master control board sends said multicast message to the CPU for processing.

7. A master control board for use in a network device comprising a master control board and at least one interface board, the master control board comprising:
an entry storage module, which is a hardware module, to store multicast entries that are in hash conflict with multicast entries already configured on an interface board;
a receiving module to receive a multicast message redirected to the master control board by an interface board; and
a forward processing module to, when a multicast entry that matches said multicast message is found in the multicast entries stored in said entry storage module, forward said multicast message according to the matching multicast entry.

8. The master control board according to claim 7, wherein said forward processing module is to
find out whether there is a multicast entry that matches the address and VLAN information of said multicast message in the L3_entry entries stored in said entry storage module, if so, then
copy said multicast message and an IPMC index corresponding to the matching multicast entry to each interface board, so that each interface board finds a corresponding IPMC entry according to said IPMC index and forwards said multicast message to a downstream device according to the outlet in said IPMC entry.

9. A network device, comprising: a multicast entry configuring module, at least one interface board and a master control board, wherein:
the multicast entry configuring module to, when a multicast entry to be configured on an interface board is in hash conflict with multicast entries already configured on the interface board, configure it onto the master control board;
each interface board to, when receiving a multicast message as a multicast inlet, search in the multicast entries configured on the interface board for a multicast entry that matches the multicast message; if a matching multicast entry is found, forward said multicast message according to the matching multicast entry; otherwise, send said multicast message to the master control board; and
the master control board to, when a multicast entry that matches said multicast message is found in the multicast entries configured thereon, forward said multicast message according to the matching multicast entry.

10. The network device according to claim 8, wherein: said multicast entry configuring module is to,
determine a hash keyword corresponding to a multicast entry to be configured, based on the (S, G, V) information of the multicast entry; and
configure the multicast entry according to the determined hash keyword.

11. The network device according to claim 10, wherein: said multicast entry configuring module is further to,
compare the hash keyword of the multicast entry with the hash keyword of each hash bucket for storing multicast entries in a L3_entry table of the interface board,
if the hash keyword of the multicast entry is identical with the hash keyword of a hash bucket in the L3_entry table, and the hash bucket has currently reached the maximum capacity, then
configure the (S, G, V) information of the multicast entry into a hash bucket having the same hash keyword in a L3_entry table of the master control board, in case that this hash bucket has not reached the maximum capacity.

12. The network device according to claim 11, wherein said multicast entry configuring module is further to configure an IPMC index corresponding to each of the hash buckets on the master control board, and configure an IPMC entry corresponding to the IPMC index on each interface board.

13. The network device according to claim 9, wherein said master control board comprises:
an entry storage module, which is a hardware module, to store multicast entries that are in hash conflict with multicast entries already configured on an interface board;
a receiving module to receive a multicast message redirected to the master control board by an interface board; and
a forward processing module to, when a multicast entry that matches said multicast message is found in the multicast entries stored in said entry storage module, forward said multicast message according to the matching multicast entry.

14. The network device according to claim 13, wherein: said forward processing module is to
find out whether there is a multicast entry that matches the address and VLAN information of said multicast message in the L3_entry entries stored in said entry storage module, if so, then
copy said multicast message and an IPMC index corresponding to the matching multicast entry to each interface board, so that each interface board finds a corresponding IPMC entry according to said IPMC index and forwards said multicast message to a downstream device according to the outlet in said IPMC entry.
